(19) United States
(12) Patent Application Publication
(10) Pub. No.: US 2022/0405026 A1
(43) Pub. Date: Dec. 22, 2022

(54) INFORMATION PROCESSING DEVICE, PRINTER, INFORMATION PROCESSING SYSTEM, AND INFORMATION PROCESSING METHOD

(71) Applicants: Takeshi SHIKAMA, Kanagawa (JP); Ko TOKUMARU, Tokyo (JP); Hiroki TANAKA, Kanagawa (JP)

(72) Inventors: Takeshi SHIKAMA, Kanagawa (JP); Ko TOKUMARU, Tokyo (JP); Hiroki TANAKA, Kanagawa (JP)

(21) Appl. No.: 17/772,155

(22) PCT Filed: Dec. 8, 2020
(86) PCT No.: PCT/IB2020/061612

§ 371 Date: Apr. 27, 2022

(30) Foreign Application Priority Data
Dec. 18, 2019 (JP) 2019-228681
Nov. 10, 2020 (JP) 2020-187278

(51) Int. Cl. G06F 3/12; G06K 15/10; B41J 29/38

(52) U.S. Cl. CPC G06F 3/1208; G06F 3/1256; G06F 3/1292; G06K 15/102; B41J 29/38

(57) ABSTRACT

An information processing device communicable with a printer includes a print data generation unit configured to generate print data corresponding to each of a plurality of elements designated as print targets for printing by the printer. The elements are of data in rows and columns. The information processing device further includes a transmission control unit configured to transmit the print data generated by the print data generation unit to the printer.

### TECHNICAL FIELD

Embodiments of the present disclosure relate to an information processing device, a printer, an information processing system, and an information processing method.

### BACKGROUND ART

In recent years, as laptop personal computers become compact and smart devices have spread, compactness and portability of printers are desired. For example, PTL 1 discloses a handheld printer from which a paper conveyance mechanism is omitted for enhancing compactness and portability.

The handheld printer disclosed in PTL 1 receives data of image to be printed from, for example, a smart device or a personal computer. A user holds a housing of the handheld printer with hand and operates the printer on a recording medium such as a notebook or paper. As a result, ink is discharged according to the amount of movement, and printing according to the received data as target of print processing (print target data) is performed on the recording medium.

### CITATION LIST

### Patent Literature

[PTL 1]
Japanese Translation of PCT International Application Publication No. JP-T-2010-520087

### SUMMARY OF INVENTION

### Technical Problem

Referring to FIGS. 19A and 19B, a description is given below of printing by a conventional handheld printer 200 of delimited data in rows and columns (row-column format) illustrated in FIG. 19A (for example, comma separated value (CSV) format). As the conventional handheld printer 200 is operated several times depending on the size of table data, the conventional handheld printer 200 can print the entire table data as illustrated in FIG. 19B. However, the conventional handheld printer 200 has a following drawback. In the case of printing elements of the data (in the example illustrated in FIG. 19A, “2019/11/19,” “part sample A,” “A00001,” etc.) respectively in designated areas of an actual part sample A illustrated in FIG. 19C, it is necessary to transmit data one by one from the smart device to the handheld printer 200 as illustrated in FIG. 19D. Thus, usability is poor.

### Solution to Problem

In view of the foregoing, an object of the present disclosure is to provide an information processing device, a printer, an information processing system, an information processing system, and an information processing method that facilitates individual printing of elements of data in rows and columns.

In order to achieve the above-described object, there is provided an information processing device communicable with a printer, as described in appended claims. Advantageous embodiments are defined by the dependent claims.

Advantageously, the information processing device includes a print data generation unit configured to generate print data corresponding to each of a plurality of elements designated as print targets for printing by the printer. The elements are of data in rows and columns. The information processing device further includes a transmission control unit configured to transmit the print data generated by the print data generation unit to the printer.

### Advantageous Effects of Invention

An aspect of the present disclosure provides an effect of facilitating individual printing of elements of data in rows and columns.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a diagram illustrating a configuration of a printing system according to an embodiment of the present disclosure;

FIG. 2 is a block diagram illustrating a configuration of a mobile communication terminal of the printing system illustrated in FIG. 1;

FIG. 3 is a block diagram illustrating a functional configuration of the mobile communication terminal illustrated in FIG. 2;

FIG. 4 is a perspective view of a handheld printer of the printing system illustrated in FIG. 1;

FIG. 5 is a block diagram illustrating a configuration of the handheld printer illustrated in FIG. 4;

FIG. 6 is a block diagram illustrating a functional configuration of a controller of the handheld printer illustrated in FIG. 5;

FIG. 7 is a sequence chart illustrating a flow of batch generation of print data in a mobile communication terminal illustrated in FIG. 2;

FIG. 8 is a flowchart illustrating a flow of display control of a data acquisition screen on a display of the mobile communication terminal illustrated in FIG. 2;

FIG. 9 is a diagram illustrating an example of data of a comma separated value (CSV) file;

FIG. 10 is a diagram illustrating an example of a data acquisition screen on the display of the mobile communication terminal illustrated in FIG. 2;

FIG. 11 is a diagram illustrating an example of a pull-down menu for selecting a data print form on the data acquisition screen in FIG. 10;

FIG. 12 is a diagram illustrating an example of an edit screen of data selected by a user on the data acquisition screen in FIG. 10;

FIG. 13 is a diagram illustrating an example of an edit screen of a Quick Response (QR) code on the display of the mobile communication terminal illustrated in FIG. 2;

FIG. 14 is a diagram illustrating an example of an animation (a preview) of text to be printed and an operation direction of the handheld printer on the display of the mobile communication terminal illustrated in FIG. 2;

FIG. 15 is a diagram illustrating an example of an edit screen of a barcode on the display of the mobile communication terminal illustrated in FIG. 2;

FIG. 16 is a diagram illustrating an example of a text edit screen on the display of the mobile communication terminal illustrated in FIG. 2;

FIG. 17 is a flowchart illustrating a printing operation of the handheld printer illustrated in FIGS. 4 to 6;

FIG. 18 is a diagram illustrating a position calculation method of a navigation sensor of the handheld printer illustrated in FIGS. 4 to 6; and

FIG. 19A is an example of data in rows and columns;

FIG. 19B is a diagram illustrating an example of a conventional printing method of the data illustrated in FIG. 19A by a handheld printer;

FIG. 19C illustrates printing of the data illustrated in FIG. 19A in respective areas on a part sample; and

FIG. 19D illustrates one-by-one transmission of the data illustrated in FIG. 19A.

### DESCRIPTION OF EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, a detailed description is given of an information processing device, a printer, an information processing system, and an information processing method according to an embodiment of the disclosure with reference to drawings.

### System Configuration

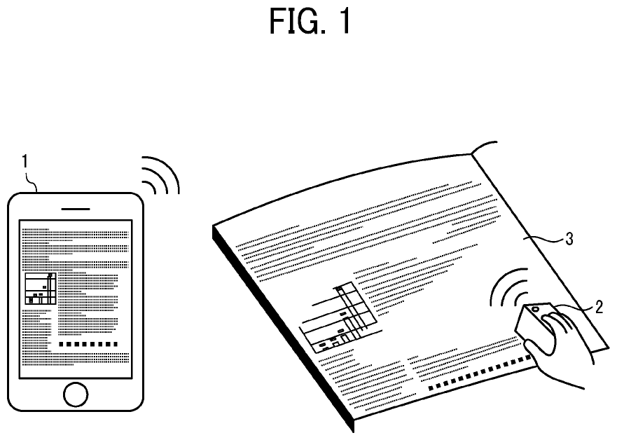

FIG. 1 is a diagram illustrating a configuration of a printing system according to the present embodiment. As illustrated in FIG. 1, the printing system according to the present embodiment includes a mobile communication terminal 1 (an example of an information processing device) and a handheld printer 2 (an example of a printer). The mobile communication terminal 1 is, for example, an electronic device, such as a smartphone, a tablet terminal, or a laptop or desktop personal computer, capable of wireless communication (or wired communication). The mobile communication terminal 1 transmits, to the handheld printer 2, a request of printing of print target data according to print data (i.e., print request).

The handheld printer 2 is made lightweight and compact by omitting a mechanism to convey a medium on which printing is made. As illustrated in FIG. 1, a user holds and operates (i.e., moves), with one hand, the handheld printer 2 on a recording medium 3. According to the amount of movement, the handheld printer 2 prints a text or an image on the recording medium 3 according to the print data (data as target of print processing) received from the mobile communication terminal 1.

### Hardware Configuration of Mobile Communication Terminal

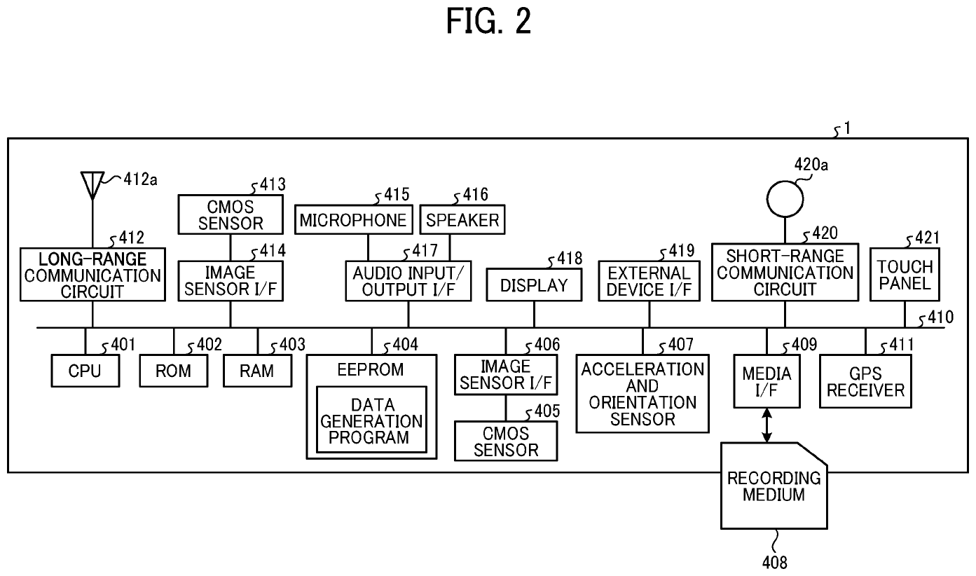

FIG. 2 is a block diagram illustrating a hardware configuration of the mobile communication terminal 1. As illustrated in FIG. 2, the mobile communication terminal 1 includes a central processing unit (CPU) 401, a read only memory (ROM) 402, a random access memory (RAM) 403, an electrically erasable programmable read-only memory (EEPROM) 404, a complementary metal oxide semiconductor (CMOS) sensor 405, an image sensor interface (I/F) 406, an acceleration and orientation sensor 407, a media I/F 409, and a global positioning system (GPS) receiver 411.

The CPU 401 controls the entire operation of the mobile communication terminal 1. The ROM 402 stores programs used by the CPU 401 or used by an initial program loader (IPL) to boot the CPU 401. The RAM 403 is used as a work area for the CPU 401. The EEPROM 404 performs reading or writing of various data such as a mobile communication terminal program under control of the CPU 401.

Further, the EEPROM 404 stores a data generation program (an example of information processing program) for generating a print request of data targeted for print processing, to be transmitted to the handheld printer 2. As will be described later, the CPU 401 controls each unit based on the data generation program so that desired print data can be easily generated and transmitted to the handheld printer 2.

The CMOS sensor 405 generates image data corresponding to image capture light from a subject, under the control of the CPU 401. In addition or alternative to the CMOS sensor, a different image capture device such as a charge-coupled device (CCD) image sensor may be used.

The image sensor I/F 406 is an interface for connecting the CMOS sensor 405 to a bus line 410. Examples of the acceleration and orientation sensor 407 include various sensors such as an electromagnetic compass to detect geomagnetism, a gyrocompass, and an accelerometer. The media I/F 409 is an interface for connecting a recording medium 408 such as a flash memory to the bus line 410. To and from the recording medium 408, for example, the print request of print target data is written and read out via the media I/F 409. The print request of print target data can be stored in another storage area such as the ROM 402 or the RAM 403. The GPS receiver 411 receives a GPS signal from a GPS satellite.

The mobile communication terminal 1 further includes a communication circuit 412, a CMOS sensor 413, an image sensor I/F 414, a microphone 415, a speaker 416, an audio input/output OF 417, a display 418, an external device I/F 419, a short-range communication circuit 420, an antenna 420a for the short-range communication circuit 420, and a touch panel 421.

As will be described later, on the display 418, a data selection screen for selecting desired data for printing, a data edit screen, and the like are displayed based on the data generation program. The user selects and edits desired data on the data selection screen and the data edit screen. This configuration facilitates generation of desired print data and transmission of the print data to the handheld printer 2.

The communication circuit 412 communicates with other devices via a communication network 412a. The CMOS sensor 413 captures an image of a subject and generates image data under the control of the CPU 401. The image sensor I/F 414 is an interface for connecting the CMOS sensor 413 to the bus line 410. The microphone 415 generates an audio signal which is an electric signal corresponding to collected voice. The speaker 416 outputs sound such as music or voice corresponding to the audio signal. The audio input/output I/F 417 is a circuit for inputting and outputting an audio signal between the microphone 415 and the speaker 416 under control of the CPU 401.

The display 418, such as a liquid crystal display or an organic electro luminescence (EL) display, displays an image of a subject or various icons. The external device I/F 419 is an interface for connection with various external devices. The short-range communication circuit 420 is a communication circuit in compliance with the near field communication (NFC), the Bluetooth (registered trademark), and the like. The touch panel 421 is disposed on the display 418 and detects a touch (contact operation) of the user.

The mobile communication terminal 1 further includes the bus line 410. The bus line 410 is, e.g., an address bus or a data bus configured to electrically connect the components such as the CPU 401 illustrated in FIG. 2.

### Software Configuration of Mobile Communication Terminal

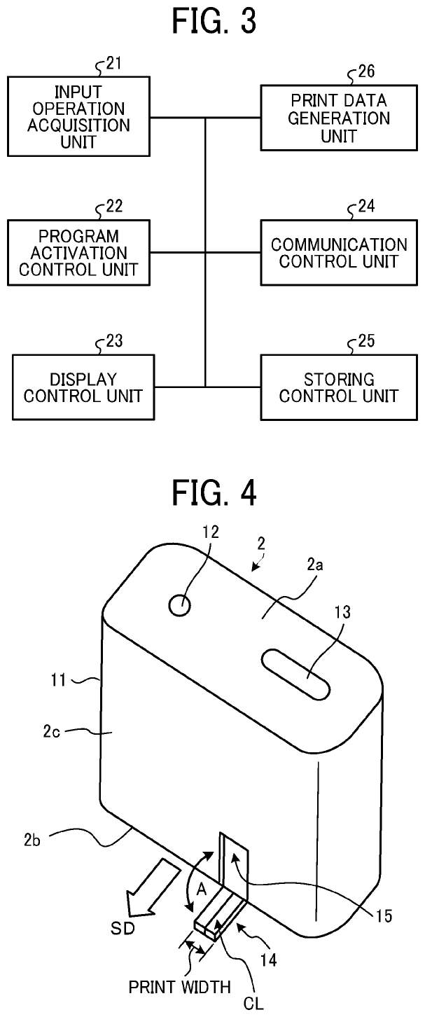

FIG. 3 is a block diagram illustrating functions implemented as the CPU 401 of the mobile communication terminal 1 operates according to the data generation program. The CPU 401 of the mobile communication terminal 1 executes the data generation program, thereby functioning as an input operation acquisition unit 21, a program activation control unit 22, a display control unit 23, a communication control unit 24, a storing control unit 25, and a print data generation unit 26.

The input operation acquisition unit 21 acquires the information input by the user via the above-mentioned input screen. The program activation control unit 22 controls activation of the data generation program. The display control unit 23 displays, on the display 418, the selection screen for the data identified as the target of print processing (e.g., a text or image to be printed), a data edit screen, and the like. The communication control unit 24 controls short-range wireless communication, such as BLUETOOTH (registered trademark) communication, with the handheld printer 2, via the short-range communication circuit 420. The storing control unit 25 controls reading of print data to be transmitted to the handheld printer 2, and writing and reading of the information input by the user via the input screen to a storage area such as the RAM 403.

The print data generation unit 26 generates print data corresponding to the elements included in the data designated as the print target.

The communication control unit 24, which is an example of a transmission control unit, transmits a plurality of print data generated by the print data generation unit 26 to the handheld printer 2.

Although the description above concerns an example in which the input operation acquisition unit 21 to the print data generation unit 26 are implemented by software, alternatively, some or all of these functions can be implemented by hardware such as an integrated circuit (IC).

In another example, the data generation program is stored in a computer-readable recording medium such as a compact disc read only memory (CD-ROM) and a flexible disk (FD), in an installable or executable file format, for distribution. In still another example, the data generation program is stored in a computer-readable recording medium such as a compact disc-recordable (CD-R), a digital versatile disk (DVD), a Blu-ray Disc (registered trademark), and a semiconductor memory, for distribution. In still another example, the data generation program is installed through a network such as the Internet or preloaded in a ROM, etc., of the device.

The handheld printer 2 may include a data generation program. In this case, the handheld printer 2 may be configured to input data with a universal serial bus (USB) memory or a secure digital (SD) card instead of inputting data from the mobile communication terminal 1.

### External Configuration of Handheld Printer

FIG. 4 is a perspective view illustrating an exterior of the handheld printer 2. As illustrated in FIG. 4, the handheld printer 2 includes a box-shaped housing 11 that can be grasped by the user with one hand. A power button 12 and a print start button 13 are disposed on an upper face 2a of the housing 11. The power button 12 and the print start button 13 are light emitting operation buttons using, for example, a light emitting diode (LED). The CPU 401 turns on light of the power button 12 from when the power button 12 is operated until when the power button 12 is operated again (while the power is on).

The print start button 13 also serves as an answerback button when a print request of data is received from the mobile communication terminal 1. Specifically, when the CPU 401 receives a print request of data from the mobile communication terminal 1, the CPU 401 causes the print start button 13 to blink a predetermined number of times, for example, five times, to notify the user of the reception of the print request. Further, when the print start button 13 is operated, the CPU 401 controls printing according to the operation of the handheld printer 2.

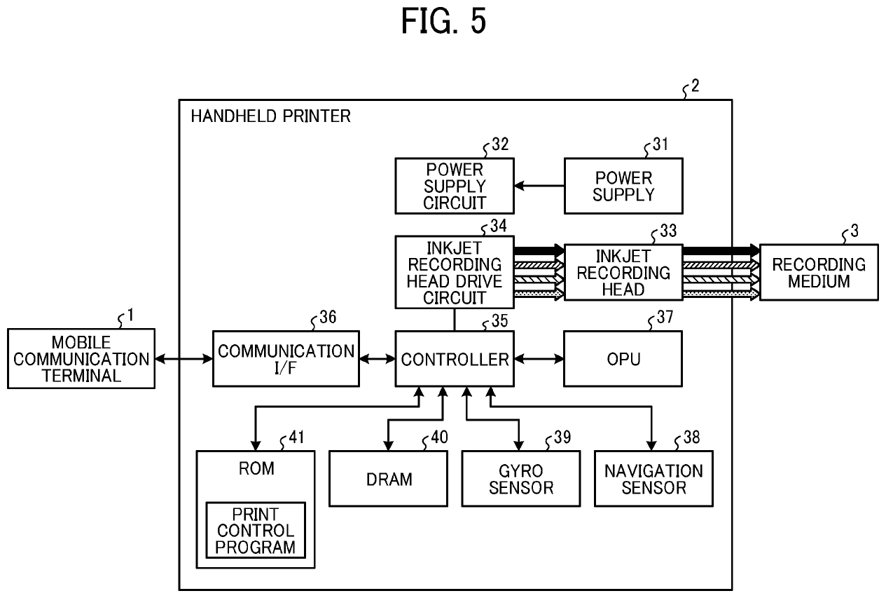

An inkjet recording head 33 (FIG. 5) serving as a printing device is disposed on a bottom face 2b of the handheld printer 2. The inkjet recording head 33 performs printing according to the movement of the handheld printer 2 operated by the user. Further, the operation direction of the handheld printer 2 is usually fixed in the direction indicated by arrow SD in FIG. 4. When the housing 11 is moved in the direction indicated by arrow SD by the user, the inkjet recording head 33 performs printing.

Further, when the housing 11 is moved in a direction other than the direction indicated by arrow SD in FIG. 4, the driving of the inkjet recording head 33 is stopped, and printing is not performed. Note that printing may be permitted in all or some of the directions according to operation direction of the user (switching of the print direction).

Further, a guide 14 is disposed on a lateral side face 2c of the housing 11 facing in the print direction indicated by arrow SD in FIG. 4, so as to project in the print direction (operating direction) indicated by arrow SD. The guide 14 is shaped like a long, rectangular plate. The guide 14 is stored in a storage portion 15 along the lateral side face 2c of the housing 11 when printing is not performed. At the time of printing, when the user hooks his or her finger nail on an upper end of the guide 14 and turns down the guide 14 in the semicircular direction indicated by arrow A in FIG. 4, the guide 14 projects in the operation direction indicated by arrow SD from a portion of the lateral side face 2c in the vicinity of the bottom face 2b of the housing 11.

The guide 14 has a width that represents a print width in which printing is performed in one operation. At a center of the guide 14, a center line CL extending from the lateral side face 2c toward the operation direction is provided. As one example, the center line CL is a thin red line. As described above, the width of the guide 14 indicates the width printed by one operation. Therefore, the center line CL indicates the center of the width printed by one operation. Therefore, the user aligns the center line CL with the center of the print start position and moves the handheld printer 2. As a result, text, images, and the like (print target data) can be printed with the center positions aligned.

### Hardware Configuration of Handheld Printer

FIG. 5 is a block diagram illustrating a hardware configuration of the handheld printer 2. As illustrated in FIG. 5, the handheld printer 2 includes a power supply 31, a power supply circuit 32, the inkjet (IJ) recording head 33, an inkjet recording head drive circuit 34, a controller 35, a communication I/F 36, an operation panel unit (OPU) 37, a navigation sensor 38, a gyro sensor 39, a dynamic RAM (DRAM) 40, and a ROM 41.

The power supply 31 is rechargeable and is a so-called secondary battery. The power supply 31 generates a drive power for the handheld printer 2. The power supply circuit 32 supplies the power from the power supply 31 to necessary components. The inkjet recording head 33 discharges ink to the recording medium 3 by an inkjet method, to print the print target such as a text and an image. The inkjet recording head drive circuit 34 controls driving of the inkjet recording head 33 in accordance with the data of print target such as a text or an image to be printed. The controller 35 controls the entire handheld printer 2.

The communication I/F 36 is for wireless communication with the mobile communication terminal 1 by short-range wireless communication such as BLUETOOTH (registered trademark). The OPU 37 includes an LED for displaying the state of the handheld printer 2, a switch for the user to instruct the handheld printer 2 to form an image, and the like. However, the OPU 37 is not limited thereto, and may further include a liquid crystal display or a touch panel. The OPU 37 may further has an audio input capability.

The navigation sensor 38 is configured to detect the amount of movement of the handheld printer 2 in an X-axis direction and in a Y-axis direction. The gyro sensor 39 is configured to detect the angular velocity applied to the handheld printer 2. The DRAM 40 and ROM 41 are storage areas for, for example, print data and data indicating the print direction (print direction data). Further, the ROM 41 stores a print control program and drive waveform data of the inkjet recording head 33.

In the handheld printer 2 having the above-described configuration, in response to a reception of print request of data from the mobile communication terminal 1, the controller 35 calculates the position of each nozzle of the inkjet recording head 33 based on information input from the navigation sensor 38 and the gyro sensor 39. While the user operates the handheld printer 2, the controller 35 continuously calculates the position of each discharge nozzle and acquires only the print data corresponding to the calculated position from the DRAM 40. Then, the controller 35 compares the position of the acquired image with the position of each nozzle. When determining the agreement between the compared positions, the controller 35 supplies the print data of the nozzle to the inkjet recording head drive circuit 34.

The inkjet recording head drive circuit 34 supplies print timing information together with the print data to the inkjet recording head 33. Based on the print timing information, the inkjet recording head 33 discharges ink corresponding to the print data onto the recording medium 3. As a result, an image or text is recorded on the recording medium 3 according to the print data designated by the user.

### Functional Configuration of Controller

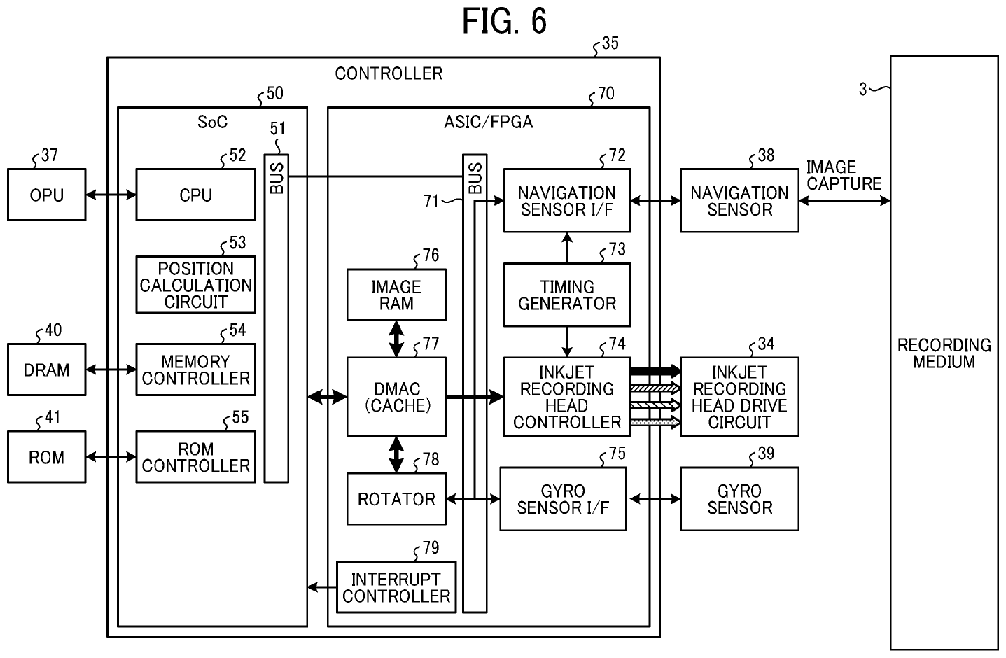

FIG. 6 is a block diagram illustrating a configuration of the controller 35 of the handheld printer 2 illustrated in FIG. 5. As illustrated in FIG. 6, the controller 35 includes a system on chip (SoC) 50 and an application-specific integrated circuit/field-programmable gate array (ASIC/FPGA) 70. The SoC 50 and the ASIC/FPGA 70 is interconnected through respective bus lines 51 and 71.

The SoC 50 includes, in addition to a CPU 52, a position calculation circuit 53 that performs position calculation, a memory controller 54 that controls writing to and reading from an external memory such as a DRAM, and a ROM controller 55 that controls writing and reading of data to and from the ROM 41.

The ASIC/FPGA 70 includes a navigation sensor I/F 72, a timing generator 73 (e.g., a circuit), an inkjet recording head controller 74, a gyro sensor I/F 75, an image RAM 76, a direct memory access controller (DMAC) 77, a rotator 78, and an interrupt controller 79.

The navigation sensor I/F 72 stores a movement amount AX in the X-axis direction and a movement amount AY in the Y-axis direction of the handheld printer 2 in an internal register. The gyro sensor I/F 75 stores an angular velocity ω received from the gyro sensor 39 in an internal register. The timing generator 73 notifies the navigation sensor I/F 72 of the timing of reading of the information from the navigation sensor 38, and notifies the inkjet recording head controller 74 of the drive timing for printing.

The DMAC (CACHE) 77 and the rotator 78 read the print data around each nozzle of the inkjet recording head 33 from the DRAM 40 (or the ROM 41) based on the position information calculated by the position calculation circuit 53 of the SoC 50. Then, the DMAC (CACHE) 77 and the rotator 78 rotate the read print data according to the position and inclination of the inkjet recording head 33, and supply the read image data to the inkjet recording head controller 74.

The image RAM 76 temporarily stores the print data read from the DRAM 40 by the DMAC (CACHE) 77. The inkjet recording head controller 74 (a discharge control unit) supplies control signals and the print data to the inkjet recording head drive circuit 34. In response to completion of the communication between the navigation sensor I/F 72 and the navigation sensor 38, the interrupt controller 79 notifies the SoC 50 of the completion of the communication therebetween. The interrupt controller 79 also notifies the SoC 50 of a status such as an error.

### Batch Generation of Print Data

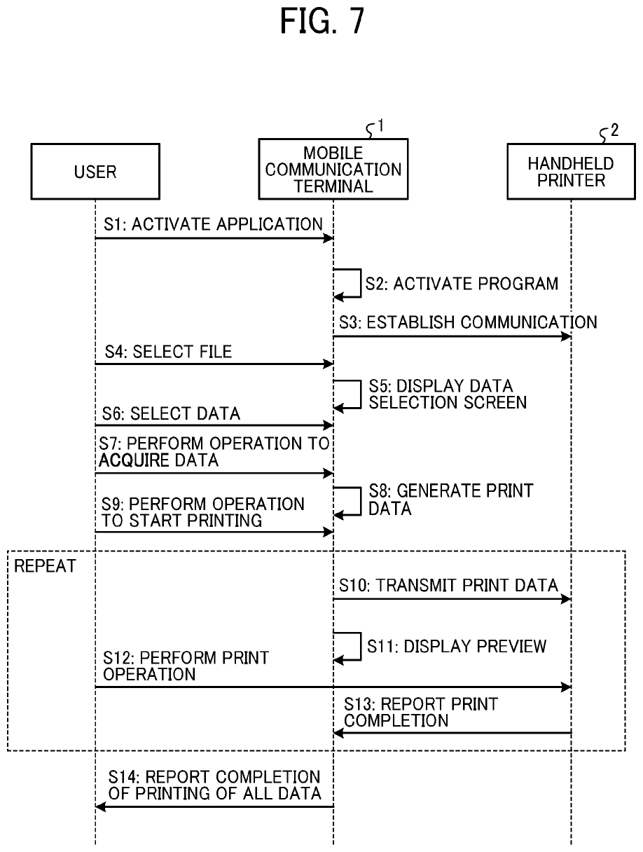

Next, a description is given of batch generation of print data in the printing system having the above-described configuration, according to the present embodiment. FIG. 7 is a sequence diagram illustrating the flow of the batch generation of the print data. In FIG. 7, in response to activation operation of the data generation program (application) on the mobile communication terminal 1 by the user (S1), the input operation acquisition unit 21 of the mobile communication terminal 1 illustrated in FIG. 3 accepts the activation operation (an input operation) and notifies the program activation control unit 22 of the reception of the activation operation. In response to a reception of the notification of the activation operation, the program activation control unit 22 reads out the data generation program stored in the storage area such as the EEPROM 404 illustrated in FIG. 2 and controls the activation (S2).

In response to the activation of the data generation program, the communication control unit 24 controls the short-range communication circuit 420 to establish, for example, a BLUETOOTH (registered trademark) communication with the handheld printer 2 (S3).

Next, the user selects print target data (e.g., a file) to be acquired (S4). The file to be acquired is, for example, a file created in advance by the user, and is stored in a storage area such as the RAM 403 or the EEPROM 404 as a file in a predetermined format such as a comma separated value (CSV) format, that is, data (e.g., table data) in rows and columns (row-column format).

The format of the acquired data may be a format other than the CSV format in which values (fields) are separated with commas. For example, the predetermined format may be a tab-separated values (TSV) format in which values are separated by tab characters or a space-separated values (SSV) format in which values are separated by spaces. Further, the predetermined format may be a hypertext markup language (HTML) format in which a table can be created using table tags.

Further, as will be described later, the handheld printer 2 prints, on the recording medium 3, the data selected by the user among the acquired data. The print position is a given position on the recording medium 3 designated by the user. Therefore, in the acquired data, the print position is not specified.

The input operation acquisition unit 21, which is an example of a selection reception unit, receives the selection of the print data, and the display control unit 23, which is an example of a display control unit, controls the display of the data acquisition screen on the display 418 in S5 based on the received data.

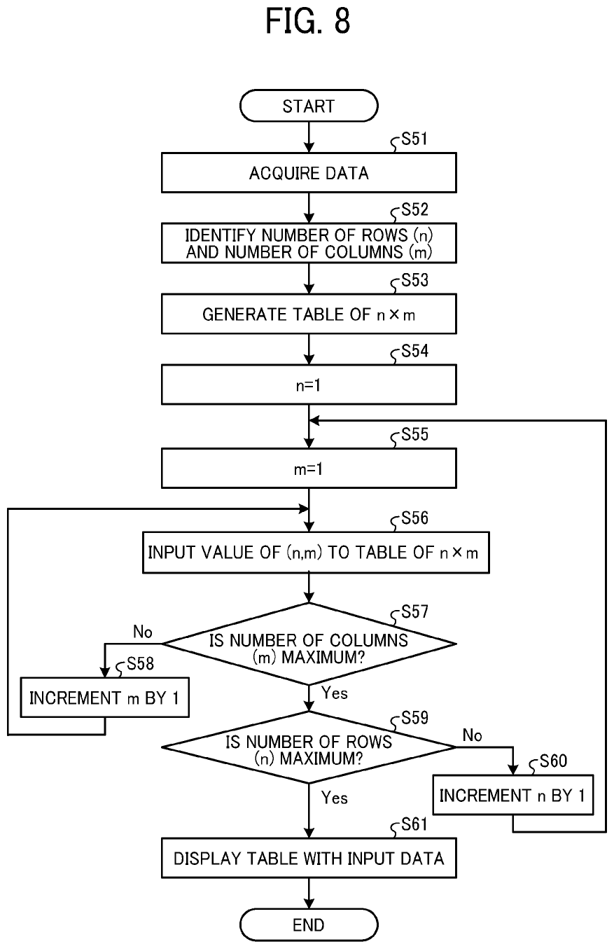

FIG. 8 is a flowchart illustrating the flow of display control of the data acquisition screen. As illustrated in FIG. 8, the display control unit 23 first acquires (or imports) the data of the file selected in S4 (S51).

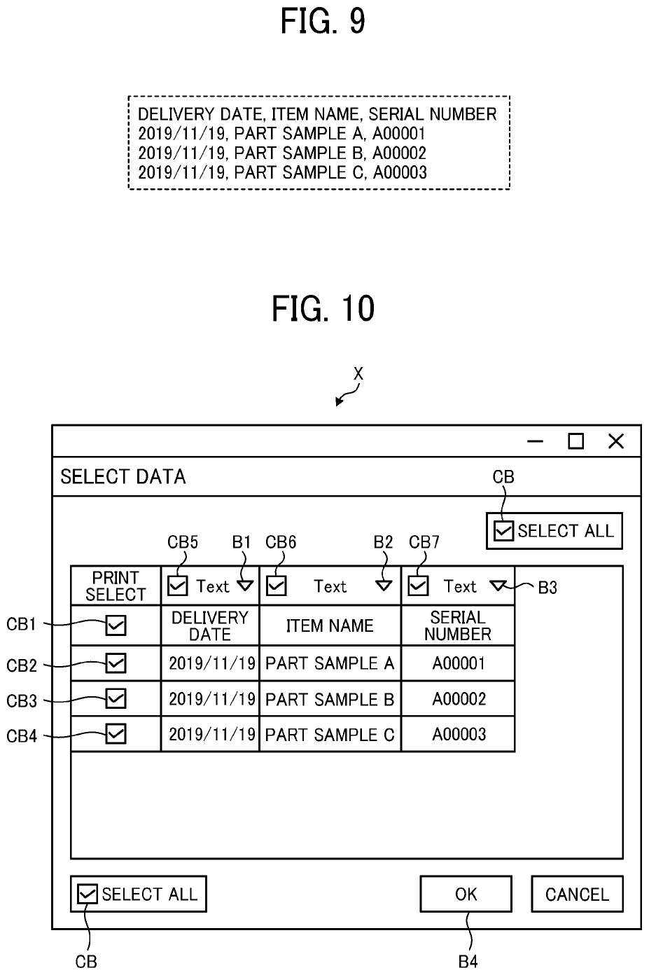

FIG. 9 is a diagram illustrating an example of data of a CSV file. In the example illustrated in FIG. 9, the data is written as follows.

Delivery date, Item name, Serial Number (line feed mark)

2019/11/19, Part sample A, A00001 (line feed mark)

2019/11/19, Part sample B, A00002 (line feed mark)

2019/11/19, Part sample C, A00003 (line feed mark) [end-of-file (EOF)]

The CSV format data is an example of two-dimensional matrix data in rows and columns. The data in the same row is separated by comma (,) one by one, and a line feed mark is attached to the last data in the row.

Although the details will be described later, the display control unit 23 identifies the number of rows “n” and the number of columns “m” of the table of the CSV file (for example, table data), and displays the values (data) embed in respective rows and columns of a table of n×m.

Returning to FIG. 8, the display control unit 23 identifies the number of rows “n” and the number of columns “m” (S52), and creates a table of n×m (S53).

In S54, the display control unit 23 initializes the number of rows “n” (n=1), and initializes the number of columns “m” (m=1) in S55.

Next, the display control unit 23 inputs the value (data) of (n,m) into the table of n×m created in S53 (S56). First, the display control unit 23 inputs a first value (data) in a first column of a first line (1,1) into the table of n×m created in S53.

Next, the display control unit 23 determines whether the number of columns “m” has reached the maximum value (S57). In response to a determination that the number of columns “m” has not reached the maximum value (No in S57), the display control unit 23 increments the number of columns “m” by one (S58) and returns to S56.

On the other hand, in response to a determination that the number of columns “m” is the maximum value (Yes in S57), the display control unit 23 determines whether the number of rows “n” has reached the maximum value (S59). In response to a determination that the number of rows “n” has not reached the maximum value (No in S59), the display control unit 23 increments the number of rows “n” by one (S60) and returns to S55.

When the above processing is repeated and the number of rows “n” reaches the maximum value (Yes in S59), the display control unit 23 displays, on the display 418, the acquisition screen of the file including the table in which values have been input (S61).

FIG. 10 is a diagram illustrating an example of a data acquisition screen X displayed on the mobile communication terminal 1. The display control unit 23 reads the values separated by commas (,) of CSV format data written as illustrated in FIG. 9 per comma-separated value, recognizes the last value of the row based on the line feed mark, and displays a series of values per row (record) as illustrated in FIG. 10. Further, a comma (,) and a line feed mark are examples of identifying information for identifying an element as one unit of printing. The identifying information is, for example, a tab character in the TSV format, a space character in the SSV format, and a table tag in the HTML format.

In other words, each data (value) separated by a comma (,) is one element. Therefore, the display control unit 23 acquires data per element and displays the data in units of rows and units of columns.

In addition to such displaying of the data, the display control unit 23 displays checkboxes CB1 to CB7 each of which is for selecting a group of elements (data) in a unit of one row or one column, and menu display buttons B1 to B3 (reversed triangle buttons in FIG. 10) for selecting a print form such as text, QR (Quick Response) Code, or barcode for each data. The user operates the touch panel 421 to tick (check) the checkboxes CB1 to CB7 of the data to be printed. Needless to say, the number of the checkboxes CB1 to CB7 and that of the menu display buttons B1 to B3 change according to the number of rows and columns of the table of the CSV file data.

This configuration enables selecting a plurality of elements in a unit of row or a unit of column. Thus, the data acquisition screen X serves as a selection screen. For example, when the checkbox CB6 in the “Item name” column in the example of FIG. 10 is checked, Part sample A, Part sample B, and Part sample C are collectively selected as the column data. In this case, only the elements in the selected column, namely, Part sample A, Part sample B, and Part sample C are printed.

Similarly, for example, when the checkbox CB4 in the row of “A000003” in the example of FIG. 10 is checked, the elements in the row of “A00003,” namely, 2019/11/19, Part sample C, and A00003 are collectively selected as the row data. In this case, only the elements in the selected row, namely, 2019/11/19, Part sample C, and A00003 are printed.

Further, the display control unit 23 displays a select all checkbox CB that enables batch selection of elements in all rows and all columns on the data acquisition screen X. When the user checks the select all checkbox CB, the display control unit 23 displays the screen on which the checkboxes CB1 to CB7 of all the rows and columns are checked as illustrated in FIG. 10. As a result, all the elements are collectively selected and printed.

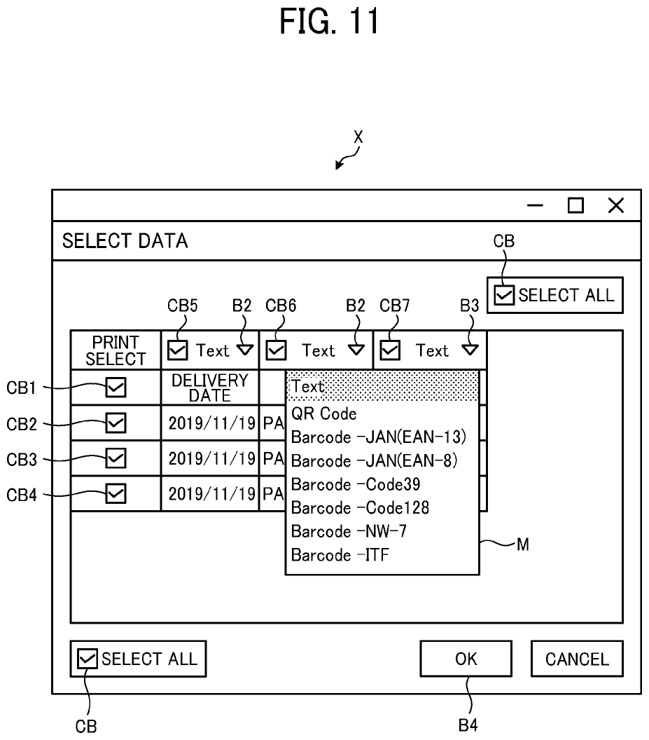

FIG. 11 is a diagram illustrating an example of a pull-down menu M for selecting a data print form. When the menu display buttons B1 to B3 (reverse triangle buttons in FIG. 10) are operated, the display control unit 23 displays the pull-down menu M for selecting a data print form as illustrated in FIG. 11. Text printing (Text) is selected as the data print form by default. Examples of print forms selectable from the pull-down menu M are, for example, a two-dimensional code, QR Code, 13-digit barcode, Japanese Article Number (JAN) or European Article Number (EAN-13), 8-digit barcode-JAN (EAN-8), code 39 barcode, code 128 barcode, narrow wide barcode (NW-7), and interleaved two of five (ITF) barcode.

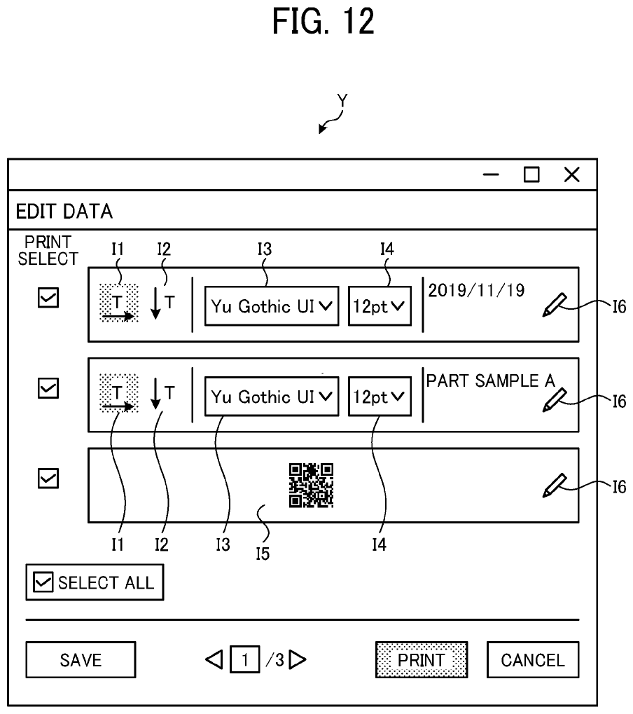

Next, in response to an operation of an OK button B4 illustrated in FIG. 10 or 11, the display control unit 23 shifts to an edit mode. FIG. 12 illustrates an example of an edit screen Y of data elements selected by the user. When the mode shifts to the edit mode, the display control unit 23 displays the edit screen Y on which setting relating to printing of each of elements currently selected by the user (elements designated as print targets) can be edited, as illustrated in FIG. 12. The edit screen Y illustrated in FIG. 12 is for a case where the user selects text as the print form of 2019/11/19 and that of Part sample A, and QR Code as the print form of A00001.

In the present embodiment, the edit screen Y is displayed separately from the data acquisition screen X, but the present disclosure is not limited thereto. Alternatively, the user interface may be configured so that editing can be performed on the data acquisition screen X.

In the example of FIG. 12, the text 2019/11/19 is given an icon I1 (including a character T and a lateral arrow) indicating that the data is printed laterally. When the user wants to perform printing in vertical printing, the user selects an icon 12 (including a character T and a vertical arrow). Further, pulldown menus 13 and 14 indicate that the text 2019/11/19 is printed in Yu Gothic UI having a font size of 12 points (12 pt). The user can change the size and the font of the text to be printed with the pull-down menus.

Similarly, in the example of FIG. 12, the text Part sample A is given the icon I1 (including a character T and a lateral arrow) indicating that the data is printed laterally. Further, the pulldown menus 13 and 14 indicate that the text Part sample A is printed in Yu Gothic UI having the font size of 12 points (12 pt). The user can change the size and the font of the text to be printed with the pull-down menus.

Further, in the example of FIG. 12, a field 15 indicates that the data of A00001 is printed as a QR Code. A pencil icon 16 illustrated in FIG. 12 is an icon operated for detailed editing.

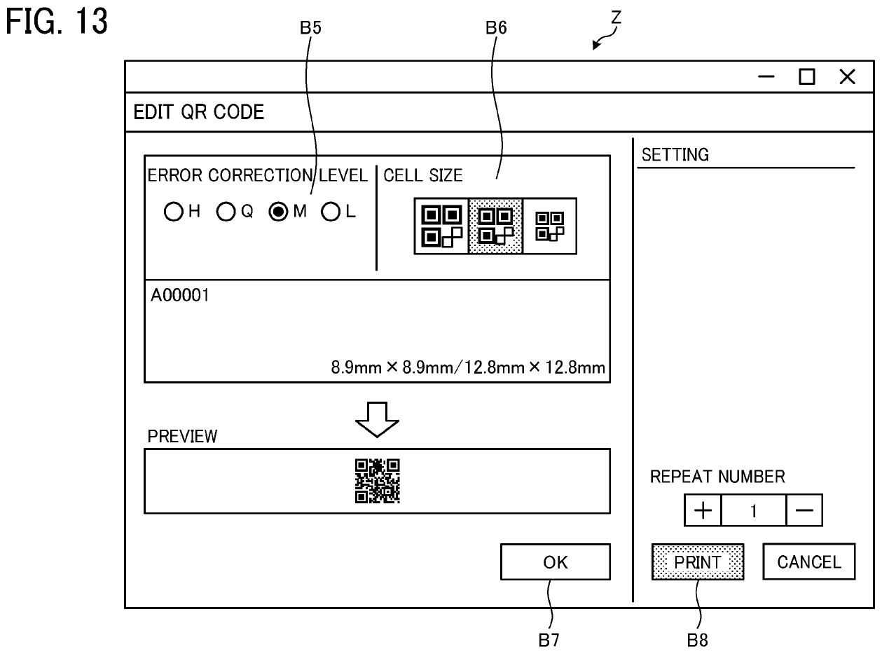

For example, when the pencil icon 16 corresponding to the QR Code is operated, the display control unit 23 displays a QR Code edit screen Z illustrated in FIG. 13 on the display 418. As one example, the display control unit 23 displays, in the QR Code edit screen Z, an error correction level selection field B5, which includes High (H), Quartile (Q), Medium (M), and Low (L) buttons, and a cell size field B6, which includes large, medium, and small buttons. Further, the display control unit 23 displays the text to be QR Coded selected in the pull-down menu M (see FIG. 11) of the data acquisition screen X illustrated in FIG. 10 and a preview image of the QR Code to be created.

In the present embodiment, as illustrated in FIG. 12, the edit screen Y is displayed separately for each row, but the present disclosure is not limited thereto. Alternatively, all the rows may be displayed together on the edit screen Y.

Returning to FIG. 7, for example, on the QR Code edit screen Z illustrated in FIG. 13, in response to selection of the error correction level and the cell size of the QR Code (S6: select data) and pressing of a confirmation button B7 labelled with “OK” (S7: perform operation to acquire data), the print data generation unit 26 illustrated in FIG. 3 generates print data corresponding to the elements selected by the user in FIG. 10 or 13 including the edited QR Code (S8).

When a plurality of elements are selected by the user, the print data generation unit 26 generates print data corresponding to each of the plurality of elements. For example, when the checkboxes CB2 to CB7 are checked in the example illustrated in FIG. 10, the print data generation unit 26 generates plurality of print data respectively corresponding to the plurality of elements “2019/11/19” to “A00003.”

Next, when the user sets the number of prints (number of repetitions) and operates the print start button B8 (the button labelled with “Print”) on the QR Code edit screen Z illustrated in FIG. 13 (S9: perform operation to start printing), the communication control unit 24, which is an example of the transmission control unit, transmits the QR Code print data to the handheld printer 2 (S10).

In transmitting the print data to the handheld printer 2, the communication control unit 24 adds information indicating the printing order to the header or the like of each print data and transmits the print data to the handheld printer 2 at a time. Alternatively, the communication control unit 24 may sequentially transmit the print data one by one (in a unit of a plurality of print data) to the handheld printer 2 according to the print order.

The print data may be transmitted to the handheld printer 2, for example, a in first-in first-out (FIFO) transmission mode, such that the data generated earlier is transmitted to the handheld printer 2 earlier.

Alternatively, the print data may be transmitted to the handheld printer 2 in consideration of the memory capacity of the handheld printer 2 as follows. The amount of print data corresponding to the memory capacity is transmitted in the first transmission, and next print data is transmitted after completion of printing of one print data, or print data corresponding to the memory capacity is transmitted after completion of printing of all the print data transmitted previously.

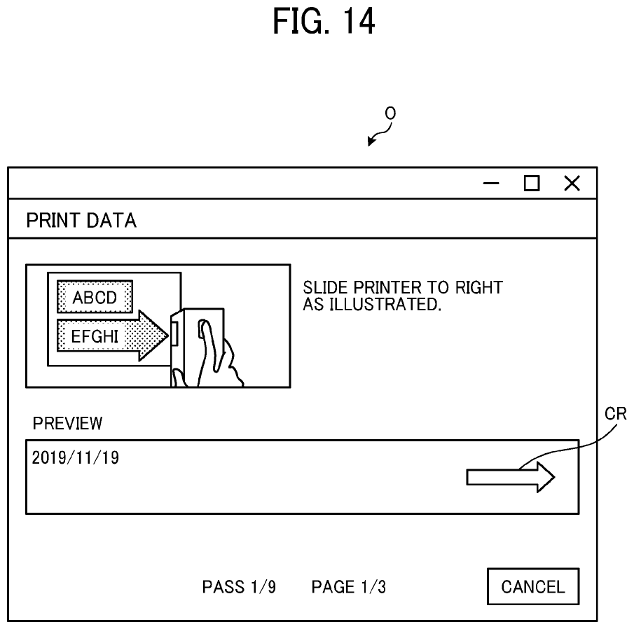

Further, as illustrated in FIG. 14, the display control unit 23 displays a screen O including animation of an arrow cursor CR that indicates the operation direction of the handheld printer 2 and moves along the operation direction in addition to a text, an image, or a QR Code to be printed (S11). Note that FIG. 14 illustrates an example in which lateral printing is selected by the user, and accordingly the above-described animation of the arrow cursor CR instructs the lateral movement of the handheld printer 2. For example, when the user selects vertical printing, an animation in which a vertical arrow cursor moves in the vertical direction, thereby instructing the vertical movement of the handheld printer 2.

The user places the handheld printer 2 at a print position on the recording medium 3 and performs print operation, that is, moves the handheld printer 2 in the operation direction indicated by the animation (S12). As a result, the desired text, the desired QR Code, and the like are printed at desired positions on the recording medium 3.

The handheld printer 2 reports print completion (or sends a print completion notification) to the mobile communication terminal 1 every time printing of one element is completed (S13). In response to the completion of printing of all elements, the display control unit 23 displays a message such as “print complete” on the display 418 to notify the user of the print completion (S14).

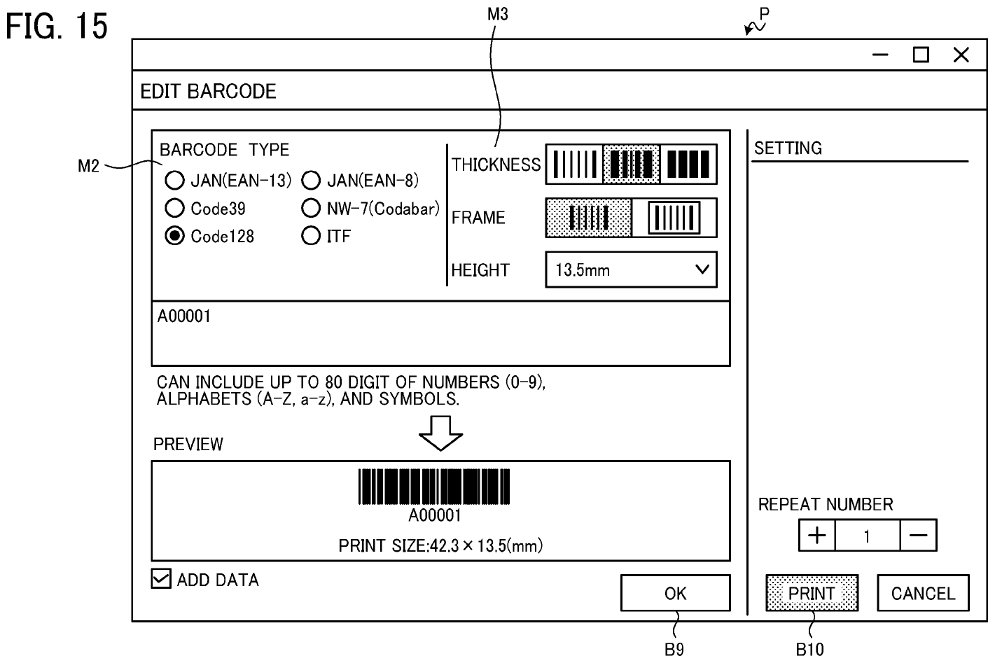

In response to selection of barcode printing from the pull-down menu M for selecting the print format illustrated in FIG. 11, and operation of the pencil icon 16 corresponding to the barcode on the data edit screen Y illustrated in FIG. 12, the display control unit 23 displays, for example, an edit screen P illustrated in FIG. 15 for the selected barcode on the display 418. In the example illustrated in FIG. 15, as the barcode type, code 128 barcode is selected by the user. The user can reselect the desired barcode type from the displayed barcode types.

The display control unit 23 displays, on an edit screen P, together with a barcode type selection field M2, a selection field M3 for selecting the barcode thickness (thin, medium, or thick), the presence or absence of the frame, and print height of the barcode. In the example of FIG. 13, the “medium” thickness of the barcode, no outer frame, and the print height of 13.5 mm are selected.

Further, the display control unit 23 displays the text to be barcoded selected (with the pull-down menu M illustrated in FIG. 11) of the data acquisition screen X illustrated in FIG. 10 and a preview image of the barcode to be created.

In response to selection of the barcode thickness, the presence or absence of the frame, etc. (S6) and operation of a confirmation button B9 labelled with “OK” (S7: perform operation to acquire data), the print data generation unit 26 illustrated in FIG. 3 generates print data of the elements selected by the user in FIG. 10 or 13 at a time (S8). The selected elements include the barcode selected and edited on the data acquisition screen X illustrated in FIG. 10.

In response to setting, by the user, of the number of prints (number of repetitions) and operating of a print start button B10 (the button labelled with “Print”) in FIG. 15 (S9), the communication control unit 24 transmits the print data of the barcode to the handheld printer 2 (S10).

In transmitting the print data to the handheld printer 2, the communication control unit 24 adds information indicating the printing order to the header or the like of each print data and transmits the print data to the handheld printer 2. Alternatively, the communication control unit 24 may sequentially transmit the print data one by one (or in a unit of a plurality of print data) to the handheld printer 2 according to the print order.

Further, as illustrated in FIG. 14, the display control unit 23 displays, on the screen O, an animation (preview) of the arrow cursor CR that indicates the operation direction of the handheld printer 2 and moves along the operation direction, in addition to a text, an image, or a barcode to be printed (S11). The user places the handheld printer 2 at a print position on the recording medium 3 and performs print operation, that is, moves the handheld printer 2 in the operation direction indicated by the animation (S12). As a result, the desired text, the desired barcode, and the like are printed at desired positions on the recording medium 3.

The handheld printer 2 reports print completion (or sends a print completion notification) to the mobile communication terminal 1 every time printing of one element is completed (S13). In response to the completion of printing of all elements, the display control unit 23 displays a message such as “print complete” on the display 418 to notify the user of the print completion (S14).

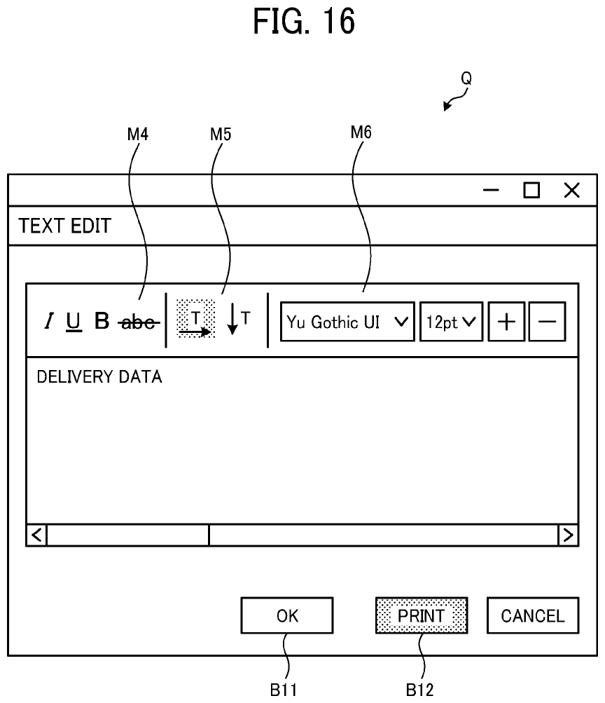

On the edit screen Y illustrated in FIG. 12, when the pencil icon 16 corresponding to the text Part sample A or the like is operated, the display control unit 23 displays a text data edit screen Q illustrated in FIG. 16 on the display 418. As one example, the display control unit 23 displays a selection menu M4 for selecting the text style, such as, whether the text is to be italicized, underlined, in bold, or lined through on the text data edit screen Q. In addition, the display control unit 23 displays a selection menu M5 for selecting vertical print or lateral print, and a selection menu M6 for selecting font type and font size. In response to selecting by the user using such a selection menu, the display control unit 23 displays preview of the text in the style, the font, and the font size selected with the selection menus M₄ to M6.

In response to selecting by the user with the selection menus M4 to M6 (S6) and operating of a confirmation button B11 labelled with “OK” is operated (S7: perform operation to acquire data), the print data generation unit 26 illustrated in FIG. 3 generates print data of the elements, including the edited text, selected by the user in FIG. 10 or 13 at a time (S8).

In response to operating, by the user, of a print start button B12 (the button labelled with “Print”) on the text edit screen Q in FIG. 16 (S9), the communication control unit 24 transmits the generated print data to the handheld printer 2 (S10).

In transmitting the print data to the handheld printer 2, the communication control unit 24 adds information indicating the printing order to the header or the like of each print data and transmits the print data to the handheld printer 2 at a time. Alternatively, the communication control unit 24 sequentially transmits the print data one by one (or in a unit of a plurality of print data) to the handheld printer 2 according to the print order.

The printing order is determined by the elements of the two-dimensional matrix data. Specifically, as one example (predetermined order), the two-dimensional matrix data (in rows and columns) is transmitted to the handheld printer 2 and is printed in the order from the leftmost element in the top row to the adjacent element on the right side, the adjacent element on the right side (end of row), and to the leftmost element in the next row on the lower side . . . .

Further, as in the screen O illustrated in FIG. 14, the display control unit 23 displays the animation (preview) of the arrow cursor CR that indicates the operation direction of the handheld printer 2 and moves along the operation direction, together with the text, the image, and the QR Code to be printed (S11). The user places the handheld printer 2 at a print position on the recording medium 3 and performs print operation, that is, moves the handheld printer 2 in the operation direction indicated by the animation (S12). As a result, the desired text, the desired barcode, and the like are printed at desired positions on the recording medium 3.

The handheld printer 2 reports print completion (or sends a print completion notification) to the mobile communication terminal 1 every time printing of one element is completed (S13). In response to the completion of printing of all elements, the display control unit 23 displays a message such as “print complete” on the display 418 to notify the user of the print completion (S14).

### Printing Operation of Handheld Printer

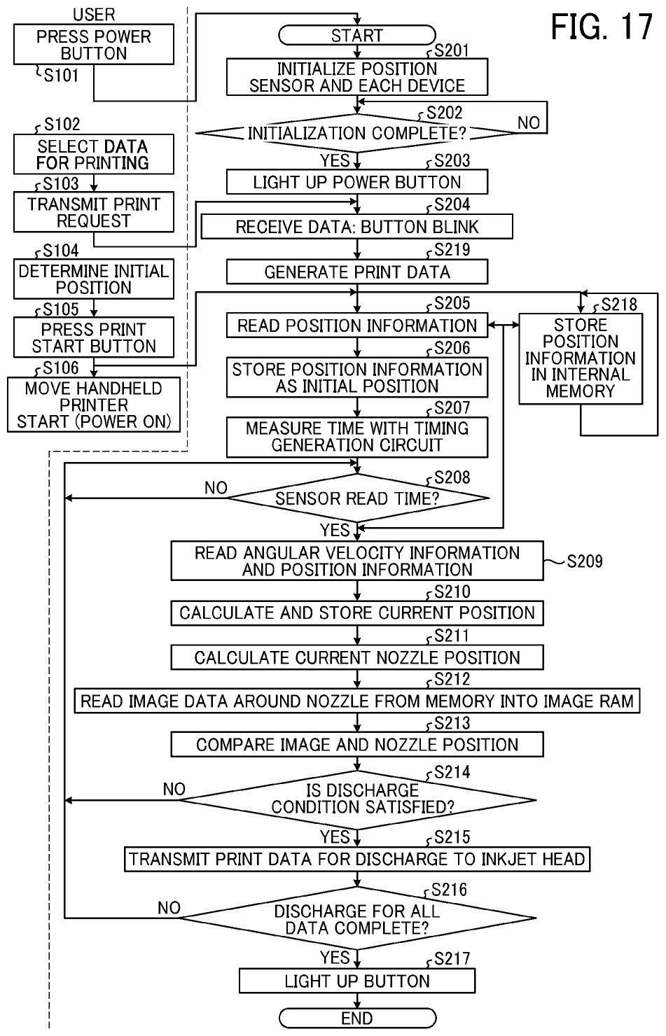

A description is given below of print operation performed by the handheld printer 2 with reference to FIG. 17. The flowchart in FIG. 17 illustrates an operation performed as the CPU 52, illustrated in FIG. 6, executes the print control program illustrated in FIG. 5.

Note that FIG. 17 illustrates the flow of printing operation performed by the handheld printer 2 for printing standard data other than table data. When printing the table data, the handheld printer 2 performs an operation different from that of the flowchart illustrated in FIG. 17 (for example, the next printing is performed after the printing is completed). Therefore, after the printing is completed, the handheld printer 2 transmits a print request (S103) and inputs the data (S204). Thus, the handheld printer 2 continues the operation to the end of the printing.

In S101, the user presses the power button 12 of the handheld printer 2. In response to this operation, power is supplied to each part from the power supply 31 of the handheld printer 2. The SoC 50 (the CPU 52) initializes each electronic device and starts up each device (S201 and S202). After the initialization is completed, for example, the power button 12 is lit up to notify the user that the printing is feasible (S203).

As described above, the user selects and edits the data as print target from an image input device such as a personal computer or the mobile communication terminal 1 (S102). The mobile communication terminal 1 transmits, to the handheld printer 2, the print target data (i.e., the above-described selected text data and the QR Code or the like) in the format of, for example, tagged image file format (TIFF) or Joint Photographic Experts Group (JPEG) based on the above-mentioned data generation program (or printer driver), via wireless communication (S103). In response to the reception of the text or image data from the mobile communication terminal 1, the SoC 50 (the CPU 52) of the handheld printer 2 performs, for example, blinking of the print start button 13, thereby notifying the user of the reception of the print target data (S204).

Further, the SoC50 (the CPU52) of the handheld printer 2 generates the print data based on the data targeted for printing received from the mobile communication terminal 1 (S219). Alternatively, the mobile communication terminal 1 may generate the print data.

The user determines the initial position of the handheld printer 2 on the recording medium 3 on which printing is performed (S104), and operates (e.g., presses) the print start button 13 (S105). After that, the user moves the handheld printer 2 on the recording medium 3. As a result, the target for printing, such as an image or text corresponding to the print data, is printed on the recording medium 3 (S106).

In response to the operation of the print start button 13, the SoC 50 (CPU 52) of the handheld printer 2 instructs each sensor I/F in the ASIC/FPGA 70 to read the information necessary for the position calculation of the navigation sensor 38. The navigation sensor 38 and the gyro sensor 39 start detecting the position information necessary for position calculation and store the position information in an internal memory (S218).

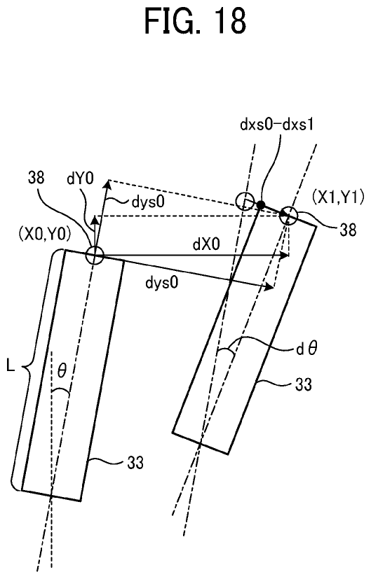

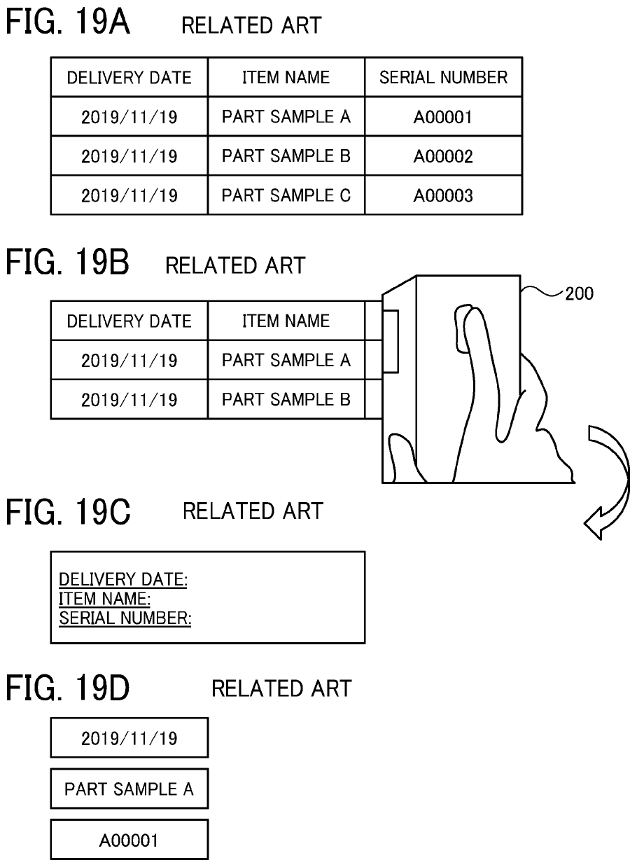

FIG. 18 is a plan view illustrating a position calculation method of the navigation sensor 38. As illustrated in FIG. 18, an angular velocity ω expressed by Equation 1 below is obtained.

$$ω = \frac{d θ}{dt} \qquad Equation 1$$

where dθ represents rotation angle for each sampling period, and dt represents a sampling time. Therefore, the angle dθ for each sampling period is expressed as Equation 2.

dθ−ω×dt Equation 2

Then, a current angle θ (time t=0 to N) is expressed as Equation 3.

$$θ = {\sum }_{t = 0}^{N} ω i \times dt \qquad Equation 3$$

The angle dθ obtained from Equation 2 and the current angle θ obtained from Equation 3 are substituted into Equations 4 to 7 to calculate the two-dimensional coordinates (X1,Y1) from the origin (X0,Y0).

dX₀=dxₛ₀×cos θ+dyₛ₀×sin θ Equation 4

dY₀×−dxₛ₀×sin θ+dyₛ₀×cos θ Equation 5

X1=X₀+dX₀ Equation 6

Y1−Y₀+dY₀ Equation 7

When the coordinates of the navigation sensor 38 is calculated, the coordinates of each nozzle can be calculated by a known calculation based on the mechanical (physical) positional relationship between the navigation sensor 38 and the nozzle since the layout of the devices are determined in advance.

Next, the navigation sensor I/F 72 communicates with the navigation sensor 38 and reads, as position information, the movement amount AX in the X-axis direction and the movement amount ΔY in the Y-axis direction of the handheld printer 2. Further, the gyro sensor I/F 75 communicates with the gyro sensor 39 and reads, as position information, the angular velocity ω of the handheld printer 2 (S205). The navigation sensor I/F 72 and the gyro sensor I/F 75 set the position based on the read information as the initial position having, for example, the X coordinate and the Y coordinate “0,0” (S206). After that, the timing generator 73 (a timing generation circuit) inside the ASIC/FPGA 70 measures time (S207). At each read timing set to each sensor (S208), the navigation sensor I/F 72 and the gyro sensor I/F 75 repeat reading of the above-mentioned information (S209).

The value detected by the navigation sensor 38 (movement amounts in the X-axis direction and Y-axis directions) and the value detected by the gyro sensor 39 (angular velocity ω) are necessary for calculating the current two-dimensional position coordinates with respect to the origin. Accordingly, preferably, such information (values) are read simultaneously.

The SoC 50 (the CPU 52) reads information from the ASIC/FPGA 70 and calculates the current position of the handheld printer 2 from the previously calculated position (X,Y), the movement amount (ΔX, ΔY) read at that time, and the angular velocity ω read at that time. Then, the SoC 50 stores the current position in the storage area (S210).

The SoC 50 (the CPU 52) transmits the calculated current position information of the handheld printer 2 to the ASIC/FPGA 70. The ASIC/FPGA 70 calculates the position coordinates of each nozzle (current nozzle position) of the inkjet recording head 33 based on the predetermined relationship between the installation positions of the navigation sensor 38 and the inkjet recording head 33 (S211).

The DMAC (CACHE) 77 and the rotator 78 of ASIC/FPGA 70 read image data around the nozzles of the inkjet recording head 33 from the storage area based on the position information, and rotate the image data (convert the coordinates) in accordance with the designated position and tilt of the inkjet recording head 33 (S212). Then, the coordinates of the image data and each nozzle position are compared (S213). In response to a determination that a set discharge condition is satisfied (S214: Yes), the image data is transmitted to the inkjet recording head controller 74 (S215).

By repeatedly executing the processes from S208 to S215, the CPU 52 controls printing of the target (e.g., an image or text) on the recording medium 3. In response to a determination that the printing according to the entire data is completed (S216: Yes), the SoC 50 (the CPU 52) controls the power button 12 or the print start button 13 to blink (S217) in order to notify the user of the completion of printing.

Even when the printing of the entire image has not been completed, the user may determine that subsequent printing is unnecessary and operate the print start button 13. As a result, subsequent printing is cancelled. Processing in the flowchart illustrated in FIG. 14 can be divided and assigned to the SoC 50 and the ASIC/FPGA 70 according to the performance of the CPU 52, the circuit scale of the ASIC/FPGA 70, and the like.

### Effects of Embodiments

As is clear from the above description, the printing system according to the present embodiment generates print data based on the element selected (and edited) by the user, of the acquired data. The printing system adds information indicating the print order of each print data to the print data and then either collectively transmits the print data to the handheld printer 2, or sequentially transmits the print data one by one (in a unit of a plurality of print data) to the handheld printer 2 according to the print order.

This configuration can improve operability in individually printing a plurality of elements of table data.

The above-described embodiments are presented as examples and are not intended to limit the scope of the present disclosure. The above-described embodiments can be implemented in other various forms, and various omissions, replacements, and changes can be made without departing from the scope of the invention. It is therefore to be understood that within the scope of the appended claims, the embodiments and variations may be practiced otherwise than as specifically described herein. For example, elements and/or features of different illustrative embodiments may be combined with each other and/or substituted for each other within the scope of this disclosure and appended claims. Any one of the above-described operations may be performed in various other ways, for example, in an order different from the one described above.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, personal digital assistant, mobile telephone, such as a Wireless Application Protocol (WAP) or third-generation (3G)-compliant phone and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a transmission control protocol/internet protocol (TCP/IP) signal carrying computer code over an IP network, such as the Internet. The carrier medium also includes a storage medium for storing processor readable code such as a floppy disk, a hard disk, a CD ROM, a magnetic tape device or a solid state memory device.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

This patent application is based on and claims priority to Japanese Patent Application Nos. 2019-228681, filed on Dec. 18, 2019, and 2020-187278, filed on Nov. 10, 2020, in the Japan Patent Office, the entire disclosure of which is hereby incorporated by reference herein.

### REFERENCE SIGNS LIST

1 mobile communication apparatus
2 handheld printer
3 recording medium
11 housing of handheld printer
12 power button
13 print start button
14 guide
15 storage portion
21 input operation acquisition unit
22 program activation control unit
23 display control unit
24 communication control unit
25 storing control unit
26 print data generation unit
151 acquisition unit

1: An information processing device communicable with a printer, comprising:
print data generation circuitry configured to generate print data corresponding to each of a plurality of elements of data in rows and columns, the plurality of elements designated as print targets for printing by the printer; and
a transmitter to transmit the print data generated by the print data generation circuitry to the printer.

2. The information processing device according to claim 1, further comprising:
display control circuitry configured to display a selection screen for selecting the plurality of elements to be printed from the data; and
a selection reception circuitry configured to receive selection of the plurality of elements in a unit of one row or one column,
wherein the print data generation circuitry is configured to generate the print data corresponding to each of the plurality of elements received by the selection reception circuitry.

3. The information processing device according to claim 1,
wherein the print data generation circuitry is configured to identify each of the plurality of elements based on identifying information included in the data.

4. The information processing device according to claim 1,
wherein the transmission control unit is configured to transmit the print data corresponding to each of the plurality of elements to the printer in a predetermined order.

5. The information processing device according to claim 1, further comprising:
display control circuitry configured to display an edit screen for editing a setting relating to printing of each of the plurality of elements.

6. The information processing device according to claim 5,
wherein the display control circuitry is configured to display the edit screen on which a print form of each of the plurality of elements is settable to a two-dimensional code.

7. An information processing system comprising:
the information processing device according to claim 1; and
a printer configured to perform printing on a medium according to the print data received from the information processing device.

8. A printer comprising:
print data generation circuitry configured to generate print data corresponding to a plurality of elements of data in rows and columns, the plurality of elements designated as print targets for printing by the printer; and
a printing device configured to perform printing on a medium according to the print data generated by the print data generation circuitry.

9. A method comprising:
generating print data corresponding to each of a plurality of elements of data in rows and columns, the plurality of elements designated as print targets for printing by a printer; and
transmitting the print data to a printer.

10. A non-transitory computer readable medium including computer instructions which when executed cause a computer to carry out the method according to claim 9.

11. The method according to claim 9, further comprising:
displaying a selection screen for selecting the plurality of elements to be printed from the data; and
receiving selection of the plurality of elements in a unit of one row or one column,
wherein the generating the print data generates the print data corresponding to each of the plurality of elements which have been selected and received.

12. The method according to claim 9, wherein:
the generating the print data includes identifying each of the plurality of elements based on identifying information included in the data.

13. The method according to claim 9, wherein:
the transmitting transmits the print data corresponding to each of the plurality of elements to the printer in a predetermined order.

14. The method according to claim 9, further comprising:
displaying an edit screen for editing a setting relating to printing of each of the plurality of elements.

15. The method according to claim 14, wherein:
the displaying displays the edit screen on which a print form of each of the plurality of elements is settable to a two-dimensional code.
